(19) United States
(12) Patent Application Publication
(10) Pub. No.: US 2018/0345472 A1
(43) Pub. Date: Dec. 6, 2018

(54) LINEAR MULTITOOL

(71) Applicants: Spencer Frazer, Lynnwood, WA (US); Beren Mckay, Lynnwood, WA (US)

(72) Inventors: Spencer Frazer, Lynnwood, WA (US); Beren Mckay, Lynnwood, WA (US)

(21) Appl. No.: 15/608,731

(22) Filed: May 30, 2017

(51) Int. Cl. B25F 1/04; B26B 11/00; B25F 1/00; B25G 1/08; B43K 29/00

(52) U.S. Cl. CPC B25F 1/04; B26B 11/005; B43K 29/004; B26B 11/008; B25G 1/085; B25F 1/003

(57) ABSTRACT

Various embodiments of substantially linear multitools are disclosed. One embodiment provides multitool having a first handle segment having a first handle portion and a second handle portion, the first handle segment having an internal channel housing a first pivot tool arm, a second handle segment having a third handle portion and a fourth handle portion, the second handle segment having an internal channel housing a second pivot tool arm, a pivot to rotatably couple the first pivot tool arm to the second pivot tool arm to create a pivot tool, wherein the pivot can rotate the first pivot tool arm and second pivot tool arm into a substantially straight arrangement allowing the first handle segment to be collinear with the second handle segment when the multitool is in a closed orientation.

### BACKGROUND

### Field of the Invention

The invention relates to straight shaped multitools and various aspects of multitools having a linear construction.

### Prior Art

Conventional multitools combine multiple tools within a two-handled design wherein when the tools are in a closed or stored orientation the two handles are folded adjacent to each other. With the two handles adjacent to each other, they can contain a common cavity that holds a large pivoting tool such as pliers, scissors, etc. Typically, the two adjacent handles each have a pivot with one of two arms of the pivoting tool and each handle rotates approximately 180 degrees about their respective pivot to transition the pivoting tool from a stored orientation to an open and useful orientation. In some cases, these multitools allow access to individual tools while in the stored orientation with the two adjacent handles.

### SUMMARY

Accordingly, multiple linear multitools are described below in the Detailed Description. For example, one embodiment provides multitool having a first handle segment having a first handle portion and a second handle portion, the first handle segment having an internal channel housing a first pivot tool arm, a second handle segment having a third handle portion and a fourth handle portion, the second handle segment having an internal channel housing a second pivot tool arm, a pivot to rotatably couple the first pivot tool arm to the second pivot tool arm to create a pivot tool, wherein the pivot can rotate the first pivot tool arm and second pivot tool arm into a substantially straight arrangement allowing the first handle segment to be collinear with the second handle segment when the multitool is in a closed orientation.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a side perspective view of one embodiment of a multitool having a straight stored orientation.

FIG. 2 shows a perspective view of the embodiment in FIG. 1 in an open orientation.

FIG. 3 shows a perspective view of internal handle structure of the multitool in FIG. 1.

FIG. 4 shows a perspective view of the opposing handle sides from those shown in FIG. 3.

FIG. 5 shows a perspective view of the tool arrangement within the handle of the embodiment shown in FIG. 1.

FIG. 6 shows a bottom perspective view of the tool arrangement shown in FIG. 5.

FIG. 7 shows a cross-section of a perspective view of half of a pivoting tool of the embodiment shown in FIG. 1.

FIG. 8 shows a cross-section of a perspective view of half of a pivoting tool and the corresponding handle housing the tang of the pivoting tool of the embodiment shown in FIG. 1.

FIG. 9 shows a perspective view showing the pivoting tool and handle components housing the pivoting tool of the embodiment shown in FIG. 1.

FIG. 10 shows a cut-away view of one side of handles housing a half of the pivoting tool shown in FIG. 9.

FIG. 11 shows a perspective view of the internal layout of multiple tools housed within the handle of the embodiment shown in FIG. 1.

FIG. 12 shows a perspective view of a pen tool shown in FIG. 11.

FIG. 13 shows a perspective view of a blade tool shown in FIG. 11.

FIG. 14 shows a side view of the interconnection between the blade tool and the handle of the embodiment shown in FIG. 1.

FIG. 15 shows a perspective view of a second embodiment of a multitool having a straight stored orientation.

FIG. 16 shows a perspective view of the embodiment in FIG. 15 in an open orientation.

FIG. 17 shows the pivot and link structure of the two main handle segments of the embodiment shown in FIG. 15.

FIG. 18 shows a cross-section of an open orientation of the handle segments of the embodiment shown in FIG. 15.

FIG. 19 shows a cross-section perspective view of the tool arrangement in a closed orientation of the embodiment shown in FIG. 15.

FIG. 20 shows a cross-section of an open orientation of the tool arrangement in the embodiment shown in FIG. 15.

FIG. 21 shows a perspective view of a closed orientation of the internal tool arrangement of the embodiment shown in FIG. 15.

FIG. 22 shows a perspective view of an open orientation of the internal tool arrangement of the embodiment shown in FIG. 15.

FIG. 23 shows a perspective view of an open orientation of the internal tool arrangement of the embodiment shown in FIG. 15.

FIG. 24 shows a top perspective view of a third embodiment of a multitool having a straight stored orientation.

FIG. 25 shows a cutaway view of the third embodiment of a multitool shown in FIG. 24.

FIG. 26 shows a side view of the third embodiment of a multitool shown in FIG. 24.

FIG. 27 shows a cutaway view of the third embodiment of a multitool shown in FIG. 24.

FIG. 28 shows a bottom perspective view of a fourth embodiment of a multitool having a straight stored orientation.

FIG. 29 shows a bottom perspective view of the fourth embodiment multitool in an open orientation.

FIG. 30 shows a side view of the fourth embodiment of a multitool shown in FIG. 28.

FIG. 31 shows a side view of an open orientation of the fourth embodiment multitool shown in FIG. 28.

FIG. 32 shows a side cutaway view of the internal tool arrangement of the fourth embodiment multitool shown in FIG. 28.

FIG. 33 shows a bottom cutaway view of the internal tool arrangement of the fourth embodiment multitool shown in FIG. 28.

FIG. 34 shows a side cutaway view of the internal tool arrangement of the fourth embodiment multitool in an open orientation.

FIG. 35 shows an end perspective cutaway view of the fourth embodiment multitool shown in FIG. 28.

FIG. 36 shows a side perspective view of a fifth embodiment multitool as disclosed herein.

FIG. 37 shows a side view of a sixth embodiment multitool as disclosed herein.

### DETAILED DESCRIPTION

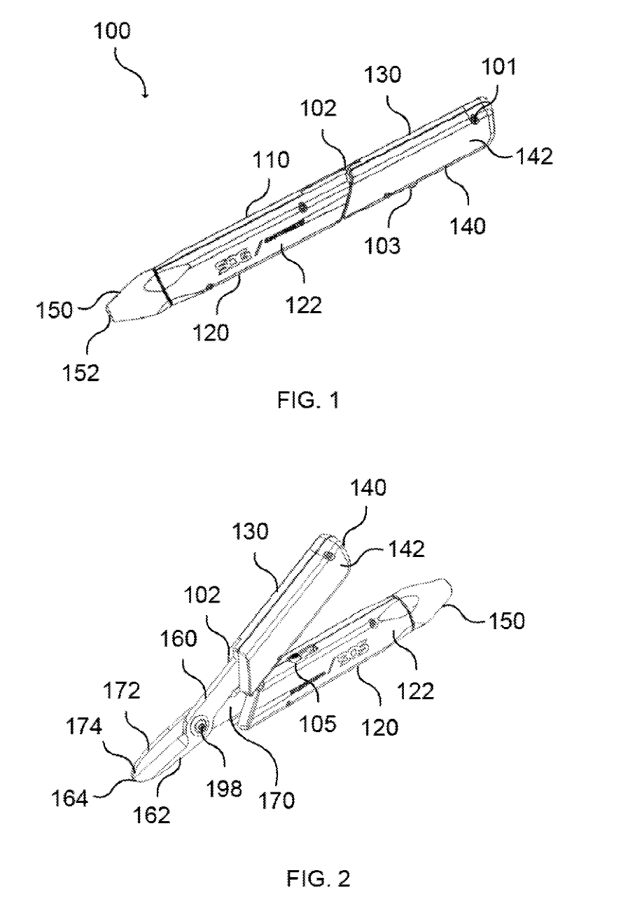

FIG. 1 shows a side perspective view of one embodiment multitool 100 having a straight stored orientation. In this embodiment, multitool 100 houses a pivoting tool and one or more end tools as described below. Multitool 100 has two handle segments, wherein a first segment includes a first handle portion 110 and a second handle portion 120 and a second segment includes a third handle portion 130 and a fourth handle portion 140. In the current embodiment, the first and second segments are arranged in a substantially linear arrangement when in a closed orientation. In the current embodiment, each handle segment has two handle portions, but other embodiments are not so limited. For example, each handle segment may be a unitary main portion or may have more than two portions. The segment in multitool 100 that includes handle parts 110 and 120 has an end that interfaces the end of the second segment at adjacent faces 102.

For multitool 100, the adjacent faces 102 are at an oblique angle to the substantially linear arrangement of the two handle segments. In this way, when in an open orientation the handles may be arranged closer to each other than if the adjacent faces were perpendicular to the substantially linear arrangement of the two handle segments. However, in other embodiments, the adjacent faces may be non-oblique, perpendicular to the substantially linear arrangement of the handle segments, etc. that join at angled common faces 102. The third and fourth handle portions are shown connected to each other by screw 101, however other embodiments may be fastened by other fasteners.

Multitool 100 also includes an opening 152 for a telescoping tool that is partially housed by tool guide 150. In some embodiments, tool guide 150 may be other shapes. In the current embodiment, tool guide 150 defines an inner channel having an opening 152 where a telescoping tool can be extended therethrough. For example, example telescoping tools include a pen, a pointer, a magnet, a light, a pencil or other marking element, a punch, an awl, or other tool that may be extended through opening 152. In the present embodiment, button 103 is shown protruding from the second handle segment. Button 103 operates a sliding blade that extends from the second handle segment. The telescoping tool, sliding tool, or other tools may be partially adjacent to the pivoting tool when the multitool is in a closed position. In other embodiments, the pivoting tool, sliding tool, telescoping tool, or other tools may be fully adjacent or not adjacent but still be relatively collinear with each other within the substantially linear arrangement of the first and second handle segments in a closed orientation.

In FIG. 1, multitool 100 is shown having a face 122 on second handle portion 120 and a face 142 on a fourth handle portion 140. In this embodiment, face 122 and face 142 are substantially coplanar with each other. In this embodiment, face 122 and 142 are also substantially planar, but other embodiments are not limited in this way and the faces may be contoured, offset from each other, not coplanar, etc. In this closed orientation, multitool 100 has a straight shaped handle housing a larger tool with a central pivot and at least one other tool within the same housing. Some embodiments may have tools arranged on one side of the central pivoting tool, on alternate sides of the central pivoting tool, on both sides of the central pivoting tool or any combination thereof. Additionally, some embodiments may have tools that project, pivot, slide or otherwise extend from one or more ends of a linear multitool. Other aspects of a linear multitool are described below with reference to FIGS. 2-35. Additionally, embodiments herein may have a lock or securing mechanism to hold a handle segment open or closed on a pivot tool arm such as a leaf spring, a ball detent, a ramp, a taper, a magnetic coupling, etc.

FIG. 2 shows a perspective view of the embodiment multitool 100 in FIG. 1 in an open orientation. In this view, multitool 100 shows a first handle segment including first handle portion 110 and second handle portion 120 and second handle segment including third handle portion 130 and fourth handle portion 140, and a pivot tool including first pivot tool arm 160 and second pivot tool arm 170 which operate around pivot 198. In multitool 100, the pivot tool is a scissor pivot tool, but other embodiments are not so limited and pivot tools may be any of multiple armed pivot tools with operating heads such as pliers, wire cutters, crimpers, cutters, locking pliers, etc. Multitool 100 includes first scissor 162 having first scissor end 164 on first pivot tool arm 160 and second scissor 172 having second scissor end 174 on second pivot tool arm 170.

With reference to FIG. 2, in the open orientation the second handle segment including third handle portion 130 and fourth handle portion 140 slides in relation to first pivot tool arm 160 wherein first pivot tool arm 160 slides, as represented by arrow 550, from a housed position where first pivot tool arm 160 is more enclosed by the first handle segment to an open orientation were first pivot tool arm 160 is extended from the first handle segment. The second handle segment can slide in relation to second pivot tool arm 170 in a similar fashion. In this way, the handles provide additional leverage to the pivot tool and provide the first handle segment and second handle segment in a more compact arrangement while the pivot tool is angled with first scissor 162 and second scissor 172 in an engaged position. With this slideable handle segment arrangement, the linear multitool can adjust from a linear closed position to a compact open position allowing easier manual manipulation while also allowing a scissor tool to be stored along with other tools in a relatively small linear multitool arrangement.

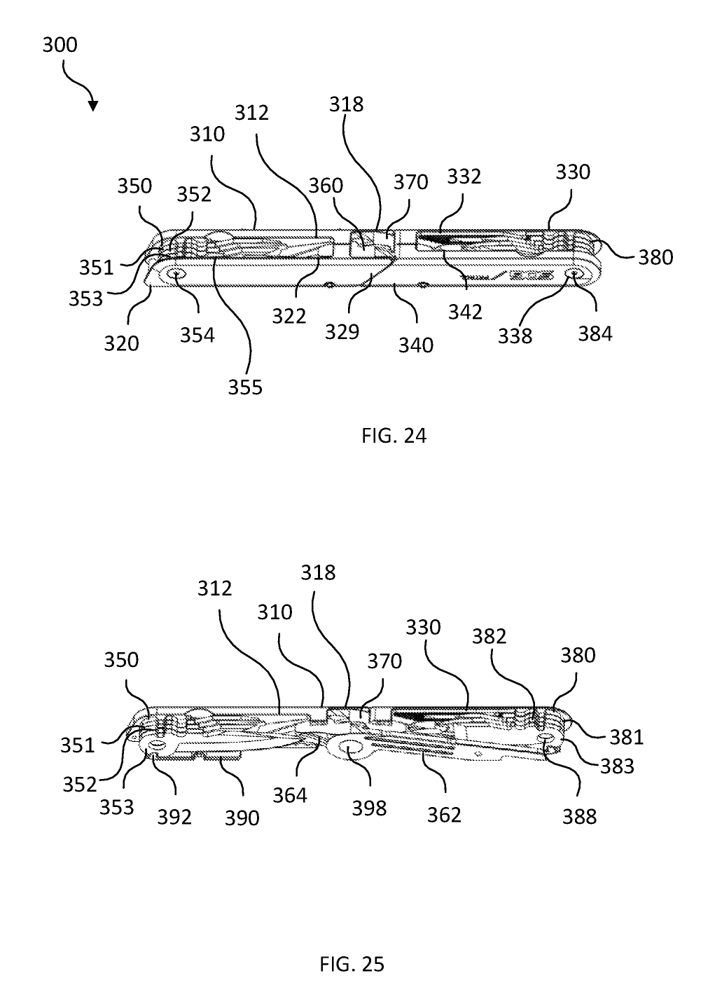

In the present embodiment, the handle segments slide substantially collinear with the first and second pivot tool arms, however other embodiments are limited in this fashion. For example, third embodiment multitool 300 and fourth embodiment multitool 400 have an offset angle between handle segments and pivot tool portions to provide more clearance for handle segments while the multitool is in an open orientation, as will be described with reference to FIGS. 24-35 below. Other embodiments may have pivot tool portions extend in other manners, for example, in a non-sliding manner, at a multiple offset angle, in a non-coplanar or other lateral offset, etc. In one alternate embodiment, a linear multitool may have a pivot tool that does not slide but is fixed in relation to handle segments. In this example embodiment, a multitool can have a substantially linear arrangement in the closed orientation and an open orientation allowing use of a pivot tool and first and second handle segments.

In the present embodiment multitool 100, first pivot tool arm 160 and second pivot tool arm 170 are offset in first and second handle segments wherein first pivot tool arm 160 is housed in and slidably engages a channel in third handle portion 130 and second pivot tool arm 170 is housed and slidably engages a channel in first handle portion 110, as shown with reference to FIG. 8. In this fashion, additional tools may be inserted into multitool 100 adjacent to and on one side of a central pivoting tool. In other embodiments, pivot tool arms may be offset in opposing handle segments, may be more centrally located in handle segments, etc. As will be explained below, the offset arrangement of the pivot tool arms in multitool 100 provide room within handle segments for a pen tool and a knife tool on one side of the pivot tool arms, however other embodiments are not limited to this arrangement.

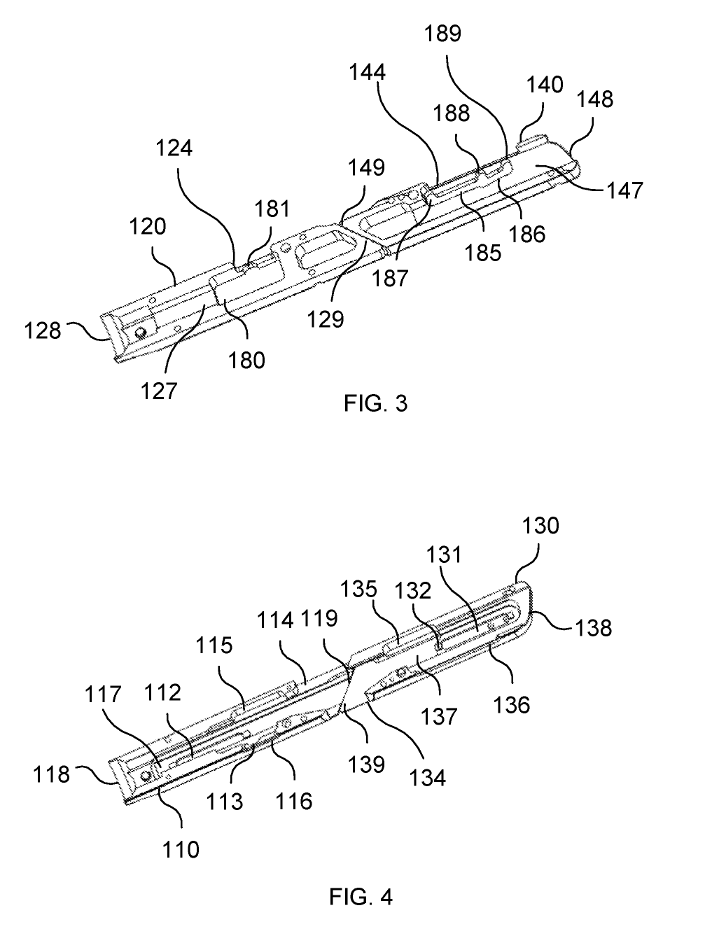

FIG. 3 shows a perspective view of internal handle structure of multitool 100 in FIG. 1 having a substantially linear arrangement between handle segments and internal tools in a closed orientation. In this closed orientation, second handle portion 120 and fourth handle portion 140 are substantially collinear and join at adjacent second angled face 129 and fourth angled face 149. Second handle portion 120 includes an opening 128 for a telescoping tool to extend from the handle, a channel 127 for telescoping tool, and inner cavity 180 to house the extension block for the telescoping tool. In this way, channel 127 is connected to opening 128 and inner cavity 180 to house and operate a telescoping too. Second handle portion 120 also includes a button opening 124 allowing a button to extend through second handle portion 120, and notch 181 to receive a boss on the extension block 157 and in turn lock the telescoping tool in an extended position.

Fourth handle portion 140 includes opening 148 for a sliding tool to extend therethrough from channel 147. Fourth handle portion 140 also includes a button opening 144 allowing a button to extend through fourth handle portion 140, and channel 185 and channel 186 having notch 187, notch 188 and notch 189 to receive a portion of a sliding tool assembly and thus allow the sliding tool to be extended or stored. In the current example, channel 186 is arranged at a different angle to channel 185 and thus separates movement from a first extended position and a second extended position.

With reference to multitool 100 in FIG. 3, in a closed orientation, a pivot tool is primarily housed in first handle portion 110 and third handle portion 130, while a telescoping tool and a sliding tool are primarily housed in second handle portion 120 and fourth handle portion 140. However, other embodiments may house tools more centrally between handle portions or may have multiple tools within any handle portion, or may be otherwise arranged such that tools are housed within a substantially linear handle when in a closed orientation.

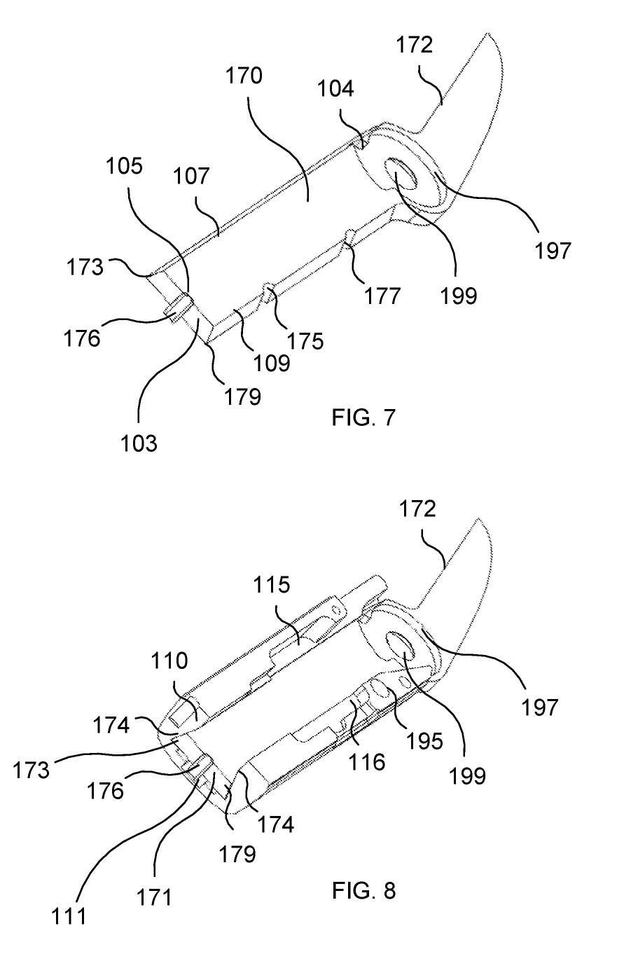

FIG. 4 shows a perspective view of first handle portion 110 and third handle portion 130, which are opposing handle sides from those shown in FIG. 3. First handle portion 110 includes angled face 119 adjacent to angled face 139 on third handle portion 130. First handle portion 110 also includes opening 118 and channel 117 which couple with opening 128 and channel 127 from second handle portion 120 to house a telescoping tool. In channel 117, slot 112 receives a boss on second pivot tool arm 170, allowing second pivot tool arm 170 to slide between an open position and a closed position. Additionally, angled walls 173 define the sides of channel 117 and in this way guide second pivot tool arm 170 along first handle portion 110, as will be explained further below with reference to FIGS. 7 and 8.

With further reference to FIG. 4, first handle portion 110 includes a pivot tool cavity 115 to receive a portion of the head of a pivot tool when multitool 100 is in a closed orientation. First handle portion 110 also include an opening 114. Opening 114 provides clearance for first scissor end 164 to clear first handle portion 110 when multitool 100 is rotated about pivot 198. In the current embodiment, opening 114 provides clearance for first pivot tool arm 160 while angled face 139 provides clearance for second pivot tool arm 170 such that the first and second handle segments can slide a smaller distance while allowing multitool 100 to adjust from a closed orientation to an open orientation, but not all embodiments are limited to having an opening, an angled face, etc.

In FIG. 4, first handle portion 110 and third handle portion 130 are rotated from the orientation of multitool 100 in FIG. 3. With reference to FIG. 4, the bottom portion of the multitool aligns with the top portion of the multitool as depicted in FIG. 3, and the top portion of the multitool as depicted in FIG. 4 aligns with the bottom portion of the multitool as shown in FIG. 3. First handle portion 110 includes opening 116, which aligns with opening 124 on second handle portion 120, and notch 113 which aligns with notch 181 from second handle portion 120. When first handle portion 110 and second handle portion 120 are coupled together, notches 113 and 181 and openings 116 and 124 coordinate to house a portion of the extension block 157 that moves a telescoping tool between open and closed positions.

With reference to FIG. 4, third handle portion 130 includes blade opening 138 which coordinates with opening 148 on fourth handle portion 140 to provide a slot for a sliding tool to project through when in an open position. Third handle portion includes blade button opening 136 which coordinates with opening 144 from fourth handle portion 140 to provide a slot wherein button 103 can slide between when the sliding tool is adjusted between open and closed positions. In the present embodiment multitool 100, the sliding tool is a blade 190, as described below, and the side of blade openings 138 and 148 can operate as a guide for the blade 190 as well as to allow open passage.

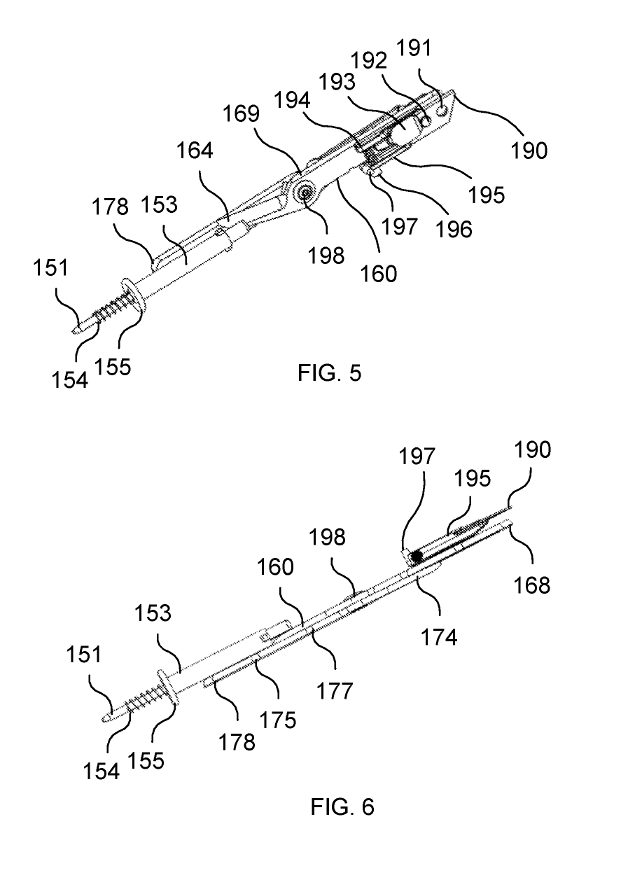

Third handle portion 130 includes pivot tool cavity 135 to receive a portion of the head of a pivot tool when multitool 100 is in a closed orientation. Third handle portion 130 includes a channel 137 for first pivot tool arm 160 through angled walls similar to angled walls 173. Additionally, third handle portion 130 includes opening 134 that can provide clearance for second pivot tool arm 170 in the open orientation and thus allow the first and second handle segments to close together in a more compact arrangement. The following paragraphs with reference to FIGS. 5 and 6 describe the internal tools and tool arrangement of multitool 100.

FIGS. 5 and 6 show side and bottom perspective views of the tool arrangement within the handle of the embodiment multitool 100 shown in FIG. 1. In multitool 100, tools include a pivot tool having a first pivot tool arm 160 and a second pivot tool arm 170, in the current embodiment the pivot tool is scissors, and a pen 151 as a telescoping tool and a blade 190 as a sliding tool. As can be seen in the closed orientation for multitool 100 in FIG. 5, first pivot tool arm 160 and second pivot tool arm 170 are arranged adjacent to each other but substantially parallel in order to fit within collinear handle segments of the multitool.

First pivot tool arm 160 is coupled with second pivot tool arm 170 by pivot 198 and includes first scissor end 164, angled tang side 169, and end 168. Second pivot tool arm 170 includes the elements of first pivot tool arm 160, and first pivot tool arm 160 also includes the elements of second pivot tool arm 170, including an open position notch 175 and closed position notch 177. The telescoping tool in multitool 100 includes a pen 151, pen spring 154, ring 155, and sheath 153. With reference to the figure, in a closed orientation, second pivot tool end 178 is situated adjacent to sheath 153 and the scissor cutting head of first pivot tool 160. Additionally, as can be seen with reference to FIG. 5, sheath 153 is partially in line with first pivot tool arm 160, thus allowing a more compact arrangement to fit within collinear handle segments as shown in FIG. 1.

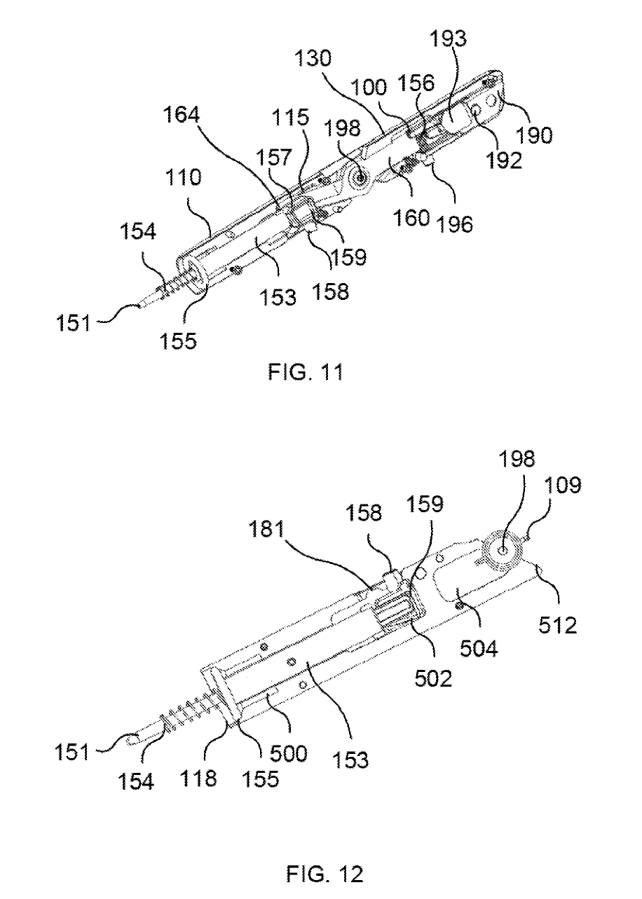

In the present embodiment, blade 190 is coupled with a blade frame by inserting post 192 into a hole in the blade 190, and is then secured in place by spring 193 which cantilevers from the blade frame and pushes the blade 190 into the blade frame. The blade frame includes a first arm 195 and a second arm 194 that are flexible and pushed apart by a spring 156 as shown in more detail in FIG. 11. The blade frame also includes a side extension 197 that cooperates with notches 187, 188 and 189 and channels 185 and 186 to slide between positions and lock into either a closed position or one or more open positions. In the current embodiment, blade 190 and the blade frame are arranged partially adjacent to end 168 of first pivot tool arm 160. In this way, the adjacent arrangement allows a relatively compact design for a multitool having a main pivot tool and a blade within substantially collinear handle segments in a closed orientation. Additionally, for multitool 100, pen 151 and blade 190 are partially collinear and adjacent to the main pivot tool having first pivot tool arm 160 and second pivot tool arm 170. However, other embodiments are not limited to this arrangement.

In the current embodiment, there are multiple levels of adjacency between tools. For example, while the sheath 153 is substantially adjacent second pivot tool arm 170 near second pivot tool end 178, the end of the sheath is offset from the sheath and is also adjacent to first pivot tool arm 160 while first pivot tool arm 160 is also collinear with the main body of the sheath 153. This allows not only a compact arrangement in a lateral direction of the collinear handle segments, but also a compact arrangement in an axial direction of the collinear handle segments, in other words, multiple levels of adjacency allow for a shorter linear multitool when in a closed orientation. The following paragraphs with reference to FIGS. 7 and 8 describe the coordinating sliding structure between the pivot tool arms and the handle portions of multitool 100.

FIG. 7 shows a cross-section perspective view of a second pivot tool arm 170 of the embodiment multitool 100 shown in FIG. 1. Second pivot tool arm 170 includes a cutting edge 172, pivot hole 199, pivot spring bore 161, and pivot spring notch 104. Second pivot tool arm 170 also has open position notch 175, closed position notch 177 that are concave notches within ramped sidewall 179. Cross section face 171 shows a boss 176 secured in a hole 105, wherein hole 105 is defined by a circular inward facing surface through second pivot tool arm 170 and pivot hole 199 is defined by a circular inward facing surface through second pivot tool arm 170. Ramped sidewalls 179 fit within angled walls 173 within channel 117 to secure the second pivot tool arm 170 to first handle portion 110. Similar ramped sidewalls and angled walls secure the first pivot tool arm 160 to third handle portion 130. Next, the ramped sidewall and notches of second pivot tool arm 170 are described in relation to first handle portion 110 with reference to FIG. 8.

FIG. 8 shows a cross-section perspective view of second pivot tool arm 170 and first handle portion 110 housing the tang of the second pivot tool arm 170 of the multitool 100 shown in FIG. 1. First handle portion 110 includes angled walls having a concave shape such that the ramped sidewalls of second pivot tool arm 170 secure the second pivot tool arm 170 against the first handle portion 110 in a slidably engaged fashion. With reference to FIG. 7, the width of second pivot tool arm 170 at edge 107, on the top right face, is less than the width of second pivot tool arm 170 at edge 109 on the back face. By having a wider portion on the deeper portion of channel 117 against ramped sidewalls 173, the ramped sidewalls and angled edges of the second pivot tool arm 170 coordinate to secure the second pivot tool arm 170 in a slideable connection to first handle portion 110.

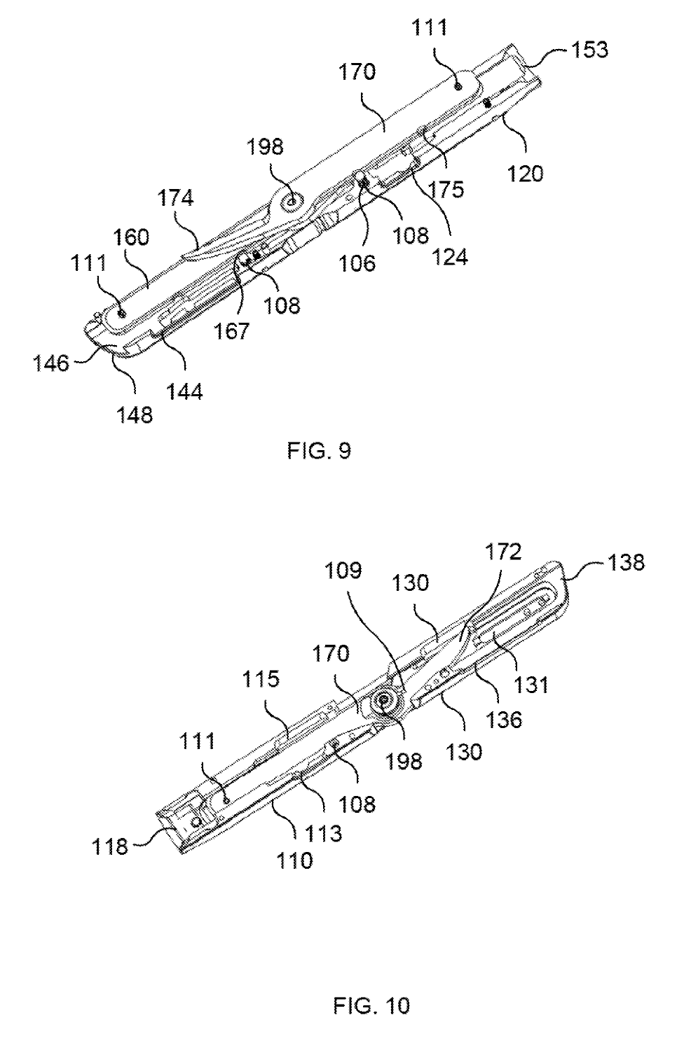

First handle portion 110 further includes a circular bore 195 to house a spring 106 and ball bearing 108 as described with reference to FIGS. 9-10 to coordinate with notches 175 and 177 to secure second pivot tool arm 170 at certain stages of extension from first handle portion 110. It can further be seen in FIG. 8 how slot 112 receives a boss 112 on second pivot tool arm 170, allowing second pivot tool arm 170 to slide between an open position and a closed position as the boss 112 slides though slot 112. In this embodiment, a sliding second pivot tool arm 170 is secured to one half of a handle segment, in this case first handle portion 110. In alternate embodiments, both portions of a two-part handle segment may coordinate to encapsulate a tool arm or tang between the connecting faces of a first handle portion and a second handle portion of the handle segment.

As shown in FIG. 8, first handle portion 110 further includes a pivot tool cavity 115 to receive a portion of the head of a pivot tool when multitool 100 is in a closed orientation. Additionally, first handle portion 110 includes opening 116, which aligns with opening 124 on second handle portion 120. When first handle portion 110 and second handle portion 120 are coupled together, openings 116 and 124 coordinate to house a portion of the extension block 157 that moves a telescoping tool between open and closed positions.

FIG. 9 shows a perspective view showing the pivot tool arms and handle components housing the pivoting tool of the multitool 100 shown in FIG. 1. In FIG. 9, multitool 100 is in a closed position and fourth handle portion 140 and second handle portion 120 are in a substantially collinear arrangement. With reference to the figure, spring 106 pushes on ball bearing 108 which is housed in a bore (cut away) in second handle portion 120 wherein ball bearing 108 is pushed into notch 177 on second pivot tool arm 170. In similar fashion. Notch 167 on first pivot tool arm 160 receives a second ball bearing 108. When opening the multitool from the illustrated closed orientation to an open orientation, second handle portion 120 is pulled in an opposite direction of fourth handle portion 140 as shown with two-directional arrow 550. The pivot tool arms will be locked in place by the ball bearings 108 in the notches 167 and 177, however, as force is increased to separate the handle portions, the ball bearings will be pushed into the springs by the contours of notch 177 and notch 167, and then will ride smoothly along the side of the second pivot tool arm 170 and first pivot tool arm 177 until the ball bearing engages notches 175 and 165, thus securing the handles portions in an open position and allowing the multitool 100 to rotate about pivot 198 to an open position having the handle segments in close alignment.

With reference to FIG. 9, in a closed position, second handle portion 120 and fourth handle portion 140 are in a collinear arrangement and opening 124 and opening 144 are shown arranged on one side of the multitool. In this fashion, a user can operate the pen 151 or blade 150 shown in other figures in and out of openings 128 and 146 respectively. In this view, a boss 111 extends up from second pivot tool arm 170 and from first pivot tool arm 160 and will coordinate with slot 131 and slot 112 in third handle portion 130 and first handle portion 110, respectively, to provide a secure stop in the open position that assists the position securing agreement between ball bearings 108 and notches 175 and 165.

As can be seen in FIG. 9, the collinear arrangement of handle segments encapsulates the first pivot tool arm 160 and second pivot tool arm 170 substantially in a line within the handle segments while the multitool is in a closed orientation. Additionally, this arrangement provides a straight outer handle exposing buttons to operate an additional tool housed within the outer handle segments through the end of fourth handle portion 140 and second handle portion 120. In this embodiment, the pen tool 151 and blade 190 telescope and slide out the end of their respective handle portions, but other embodiments may have other tool connections, such as pivoting connections, rotating connections, ratcheting connections, etc., as shown below with reference to FIGS. 24-35.

FIG. 10 shows a cutaway view of one side of handles housing a half of the pivoting tool shown in FIG. 9. FIG. 9 shows first handle portion 110 and third handle portion 130 which are the complementary handle portions to second handle portion 120 and fourth handle portion 140, respectively. FIG. 10 therefore rotates the respective handle portions from FIG. 9 a half a turn within the plane of the figures such that the end opening 148 on the left side of FIG. 9 cooperates with the end blade opening 138 on the right side of FIG. 10. Additionally, as the complementary handle portions are shown in FIG. 10 to those shown in FIG. 9, the top side of the multitool shown in FIG. 9 is also the top side of the multitool shown in FIG. 10. Further, in this cutaway view, first pivot tool arm 160 is omitted to show the internal structure of first handle portion 110 and third handle portion 130, inclusive of the second pivot tool arm 170.

With reference to FIG. 10, second pivot tool arm 170 is shown seated within first handle portion 110 and the second scissor 172 is shown housed within third handle portion 130 with multitool in the closed orientation. In this closed orientation, the end of second scissor 172 is housed within pivot tool cavity 135 in third handle portion 130, where pivot tool cavity 115 receives the end of the first scissor 162 (cutaway). Pivot 198 and spring 109 are shown, where spring 109 fits within pivot spring bore 161 in second pivot tool arm 170 and a complementary pivot spring bore in first pivot tool arm 160, wherein the ends of the spring fit within pivot spring notch 104 in second pivot tool arm 170 and a complementary pivot spring notch in first pivot tool arm 170. In the current embodiment, the pivot spring notches allow rotation of the spring for the spring to have a relaxed state while the multitool is in a closed orientation. As the multitool is rotated about pivot 198 to an open orientation, the spring 109 engages the end of pivot spring notch 104 to place the spring under load, tending to open the first and second scissor ends. In this arrangement, the scissor can therefore operate in spring opened state while the multitool is in an open orientation but also store in a substantially straight alignment within the collinear handle segments while the multitool is in a closed orientation.

With reference to FIG. 9, in the closed orientation, second pivot tool arm 170 primarily resides within first handle portion 110 and first pivot tool arm 160 is rotated 180 degrees from second pivot tool arm 170 and resides primarily within third handle portion 130. In a conventional multitool in a stored orientation, the handle segments are not collinear but are substantially parallel as they encapsulate a pivot tool such as pliers, scissors, etc. With reference back to FIG. 10, ramped portion 164 in third handle portion 130 secures second scissor 172 while the multitool is in a closed orientation. In this arrangement, while ramped portion 164 supports second pivot tool arm 170 within third handle portion 130, ball bearing 108 locks second pivot tool arm 170 in place within first handle portion 110.

In this embodiment, second pivot tool arm 170 is secured in place in an axial direction to collinear handle segments while it is also oriented 180 degrees from first pivot tool arm 160. In this closed orientation with second pivot tool arm 170 being oriented 180 degrees from first pivot tool arm 160, both ends of the pivot tool can functionally use tools that telescope, slide out, rotate out, ratchet, etc. while still in the closed orientation.

FIG. 11 shows a cutaway perspective view of the internal layout of multiple tools housed within the handle of multitool 100 in a closed orientation shown in FIG. 1. The current embodiment includes a first handle portion 110 and a third handle portion 130 that house scissors that rotate about pivot 198, a pen 151 in one end of the multitool and a sliding blade 190 in the other end of the multitool. Other embodiments may include other pivoting tools such as pliers, crimpers, etc. and other tools that may project, release, or pivot from one or more ends of a substantially linear multitool.

With reference to FIG. 11, tool guide 150 is omitted to show the internal structure of pen 151 and the accompanying telescoping/extending assembly that translates the pen 151 between an open and a closed position. Spring 154 is arranged between pen 151 and tool guide 150 and applies a force tending to keep pen 151 in a stored state within tool guide 150 and first handle portion 110 and second handle portion 120, while ring 155 provides an elastic seal between tool guide 150 and the handle segment including first handle portion 110 and second handle portion 120.

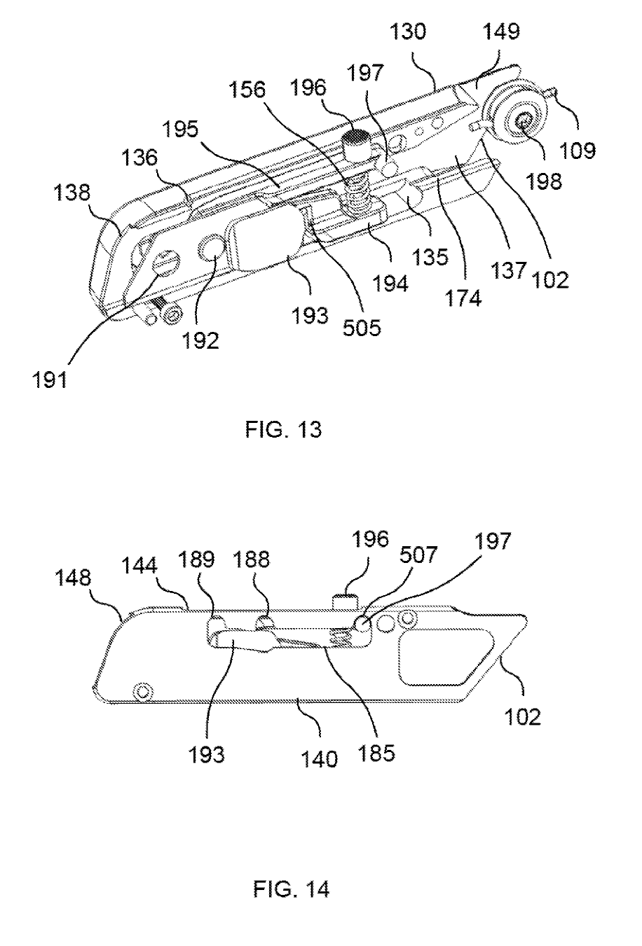

As shown in the figure, sheath 153 is adjacent to extension block 157, which includes back wall 159 and extension block ramp 502, wherein back wall 159 is in contact with the end of sheath 153 which protrudes into a cavity in extension block 157. In this embodiment, first scissor end 164 is adjacent to extension block 157 while the multitool is in a closed orientation, and second pivot tool arm 170 is situated between first scissor end 164 and first handle portion 110. With reference to the embodiment multitool shown in FIG. 11, in a closed orientation the first pivot tool arm 160 is partially housed within third handle portion 130 along with blade 190, blade post 192, spring 193, second arm 194, and first arm 195. The pen assembly and blade assembly are described in more detail with reference to FIGS. 12 and 13 in the following paragraphs.

FIG. 12 shows a cross-section perspective view of a pen 151 and assembly shown in FIG. 11. As shown, second handle portion 120 houses sheath 153 which extends to extension block back wall 159 and adjacent extension block ramp 502. Coupled with the extension block is button 158 which extends through hole 105 as shown in FIG. 2. Extension block includes ridge 504 which coordinates with notch 181 to lock the pen in an open position when button 158 is pushed toward the end of handle portion 120 having opening 118.

When the pen is in the open position, extension block 157 partially rotates within inner cavity 180 as shown in FIG. 3 such that extension block ramp 502 is parallel with the side of the end of sheath 153 within the extension block. In this way, as the extension block is rotated, pen 151 is projected out of tool guide 150 to an extended and usable position. In this view, second pivot tool arm 170 is cutaway but spring 198 is shown to show the alignment of the pen assembly within first handle portion 110 adjacent to second pivot tool arm 170. FIGS. 11 and 12 illustrate a telescoping tool, such as pen 151, residing within a handle of a multitool that in a closed orientation resides within collinear handle segments in a fashion that allows the tool to open and close by projecting out the end of the multitool.

In the current embodiment, button 158 will fold into the inside of the handles as the multitool is adjusted to an open orientation allowing use of the scissors. In this way, the button may not be inadvertently triggered while operating the scissors or other pivoting tool. However, other embodiments are not limited in this way, and may have a button exposed to use to allow use of an end tool simultaneously with an open orientation for a pivot tool. For example, the pivot tool arms and angled walls 173 may be flipped with respect to top and bottom of the respective handle segments, thus placing the buttons on the outside of the handle while the multitool is in an open orientation. Additionally, some embodiment may have alternating hidden and exposed buttons in the open orientation of the multitool, or other arrangements of multiple hidden or exposed buttons in this orientation.

FIG. 13 shows a cutaway perspective view of a blade tool shown in an embodiment multitool 100 as shown in FIG. 1. Third handle portion 130 includes opening 134 and is attached to pivot 198 having spring 109. In this cutaway view, first pivot tool arm 160 is cutaway to show channel 137 and the relationship between the blade assembly and third handle portion 130. As shown, third handle portion 130 includes pivot tool cavity 135, channel 137, opening 134, blade button opening 136, and blade opening 138. Adjacent to channel 137, post 192 is inserted through one of the holes 191 in blade 190, and blade 190 is held to a sliding tool assembly by spring 193.

Sliding tool assembly includes first arm 195, button 103, side extension 197, second arm 194 and spring slot 196. First arm 195 and second arm 194 are arranged with spring 156 extended between them such that spring 156 tends to push the first arm 195 and second arm 194 apart from each other. In this way, side extension 197 will extend into notches 187, 188 and 189 as shown in FIGS. 3 and 14.

When button 103 is pressed, side extension 197 will disengage notch 187, notch 188 or notch 189, and allow the sliding tool assembly to move as side extension moves along channels 185 and 186. In the current embodiment, side extension 197 is on one side of the sliding tool assembly and engages fourth handle portion 140, allowing a more compact arrangement for first pivot tool arm 160 to fit between sliding tool assembly and third handle portion 130.

In this way, an embodiment multitool with collinear handle segments can have multiple tools between handle portions or within a handle segment and allow the compact linear arrangement while the multitool is in the closed orientation. Additionally, this compact arrangement allows the multitool to remain in the closed orientation with a blade, pen, or other tool extending from the end of the multitool.

FIG. 14 shows a cutaway side view of the interconnection between the blade tool assembly and fourth handle portion 140 of the embodiment shown in FIG. 1. In the cutaway, channel 185 is shown as well as notch 187, notch 188, and notch 189. Through a channel opening, spring 193 can be seen behind a fourth handle portion 140. On the right side of the figure, angled face 139 is shown while on the left side of the figure, opening 148 where the blade 190 projects through is shown. With reference to the figure, button 103 is shown in button opening 144.

In this view blade 190 is housed between fourth handle portion 140 and third handle portion 130. When button 103 is pressed in, side extension 197 disengages from notch 187 and slides down channel 185 to either notch 188 or notch 189. Channel 185 is slightly offset from channel 186, in turn providing a tactile difference on button 103 between the opening positions of blade 190 where a first depression of button 103 allows side extension 197 to slide down channel 185 but stop at notch 188, while a great depression of button 103 allows side extension 197 to move into channel 186 and into notch 189, thus placing blade 190 in a more extended position through opening 148. This multiple extension distance construction allows use of different parts of blade 190 and can allow the blade to be exchanged or moved in one position while being securely held in a second position. While this embodiment has offset channels 185 and 186, other embodiments are not limited in this manner.

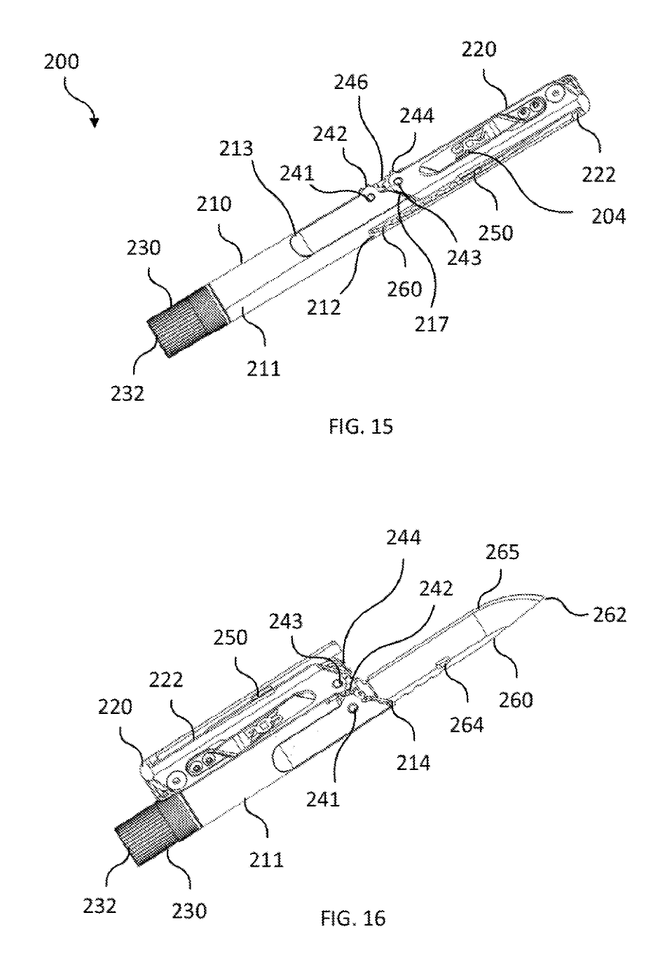

FIG. 15 shows a perspective view of a second embodiment multitool 200 having a straight stored orientation. With reference to the figure, multitool 200 includes a first handle 210 and a second handle 220 in a collinear arrangement in a closed position. In this embodiment, multitool 200 has a first pivot 241 on one end of handle 210 and another pivot 243 on an adjacent end of handle 220. Handle 210 has a gear 242 that has teeth that interconnect with teeth in gear 244 on handle 220, wherein the gear 242 has a relative center point that corresponds with pivot 241 and gear 244 has a relative center point that corresponds to pivot 243. Link 246 connects handle 210 and handle 220 with pivot 241 extending through link 246 on the end of handle 210 and pivot 243 extending through link 246 on the adjacent end of handle 220. In this way, handle 220 can rotate about pivot 243 and swing adjacent to handle 210 as link 246 also rotates about link 241, as is shown in the open position in FIG. 16.

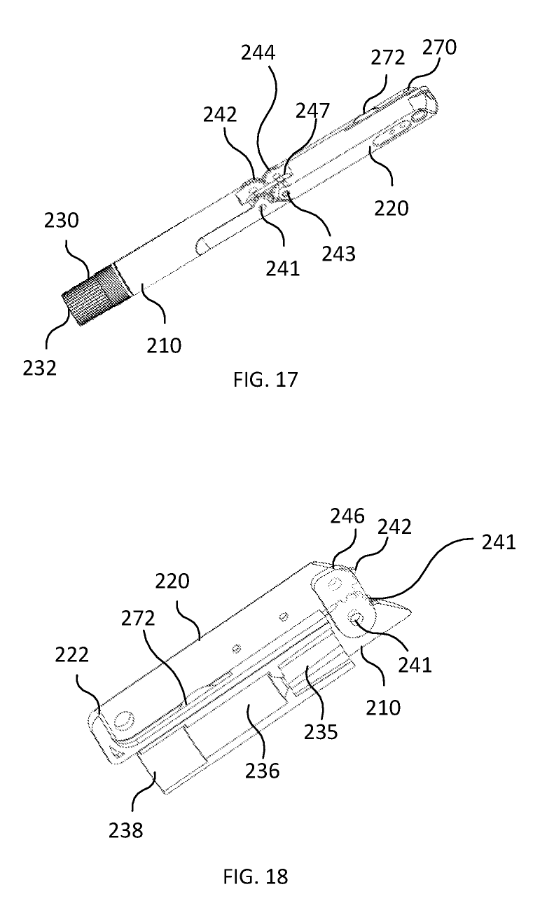

With reference to FIG. 15, multitool includes a light assembly 230 that when on can shine light out opening 232. Handle 220 includes an open channel 222 housing a knife 260 in a closed position, wherein open channel 222 is open along a side of handle 220 to allow knife 260 to pass between open and closed configurations. Handle 220 also includes an opening 272 on a side of handle 220 opposing open channel 222, as shown in FIG. 17. Handle 220 also has a lock 250 that extends into notch 264 in knife 260 to lock handle 220 over knife 260 while multitool 200 is in a closed orientation. In the current embodiment, first handle 210 includes opening 212 that aligns with open channel 222 on handle 220 and exposing a back edge of knife 260. Handle 220 is shown having a clip 204 affixed to one side of the handle.

FIG. 16 shows a perspective view of the embodiment multitool 200 shown in FIG. 15 in an open orientation. With reference to the figure, first handle 210 is shown with light assembly 230 and opening 232 on one end, and knife 260, having point 262, notch 264 and blade 265 extending from a second end. In this embodiment knife 260 is rigidly connected to handle 210 and in a closed or an open orientation of multitool 200, knife 260 and handle 210 do not change position in relation to each other. Handle 220 includes open channel 222 that houses knife 260 when multitool 200 is in a closed orientation. Second handle 220 also includes lock 250, which extends into notch 264 when handle 220 is over blade 260 and the multitool is in a closed orientation.

Handle 210 includes pivot 241, which extends through one end of link 246. Link 246 also houses pivot 243 and in turn link 246 couple first handle 210 with second handle 220. As shown in FIG. 16, handle 210 has gears 242 that interlock with gears 244 on handle 220. The interlocking gears 242 and 244, and double pivot and link connection, move the handle 220 from a closed orientation where handle 210 and handle 220 are collinear, to an open position where handle 210 and handle 220 are adjacent to each other. In this way, multitool 200 transitions from a compact closed orientation to an open orientation having a larger handle in combination while exposing knife 260 fixed to handle 210.

In the current embodiment, as handle 220 rotates from a closed position collinear with handle 210 to an open position adjacent and substantially parallel to handle 210, it undergoes an approximate 180-degree rotation while in the same time the link connecting pivot 241 and pivot 243 undergoes a 90-degree rotation.

A two-pivot rotation that translates handle 210 to an adjacent position to handle 210, however other embodiments are not limited in this way and one handle portion be constructed to mate with a second handle portion in such a way as to allow a single pivot while still having a first handle collinear with a second handle when a multitool is in a closed orientation. In the current embodiment, handle 220 rotates over the front of knife 260 to a position in front of handle 210 with respect to blade 265 of knife 260. In another embodiment, handle 220 can rotate to a back side of handle 210 with respect to blade 260, or may rotate to a side of knife 260, or other angle, while still maintaining a collinear relationship between handles when the multitool is in a closed position. As an example, a two-pivot connection could open a handle on either side of a blade and have a substantially collinear closed orientation with adjacent handles in an open orientation that exposes a blade or other tool.

FIG. 17 shows the pivot and link structure of the two main handle segments of the embodiment shown in FIG. 15. Handle 210 is shown with light assembly 230 and opening 232, and is coupled to handle 220 by gear 242 on the end of handle 210 which interlocks with gear 244 on handle 220 and link 246, which is connected to handle 210 by pivot 241 and is connected to handle 220 by pivot 243, as shown in the figures above. In this figure, knife 260 and other internal elements are cutaway from the figure to more clearly show the pivot arrangement through gears 242 and 244 as well as link 246. It should be noted that link 247 as shown in FIG. 22 corresponds to link 246 but is omitted in some views to more clearly show aspects of multitool 200. In FIG. 17, handle 220 is also rotated to show opening 272 and pivot tool element 270 which rotates to an open position through opening 272. In multitool 200, pivot tool element 270 is a combination can opener and screwdriver, but embodiments may use other pivoting tools within the principles of this disclosure.

FIG. 18 shows a cross-section of an open orientation of the handle segments of embodiment multitool 200 shown in FIG. 15. As shown in the cross-section, handle 210 is coupled with link 246 by pivot 241, and link 246 is coupled with handle 220 by pivot 243. In this figure, link 246 is shown as transparent to better illustrate the interlocking nature of teeth on gear 242 and gear 244. Handle 210 includes cavity 235, cavity 236 and opening 238. As will be described in more detail below, the cavities and opening house the connection for blade 260, and the battery for light assembly 230. Handle 220 is also shown with opening 272 from which pivot tool element 270 extends and opening 222 which covers knife 260 when multitool 200 is in a closed orientation.

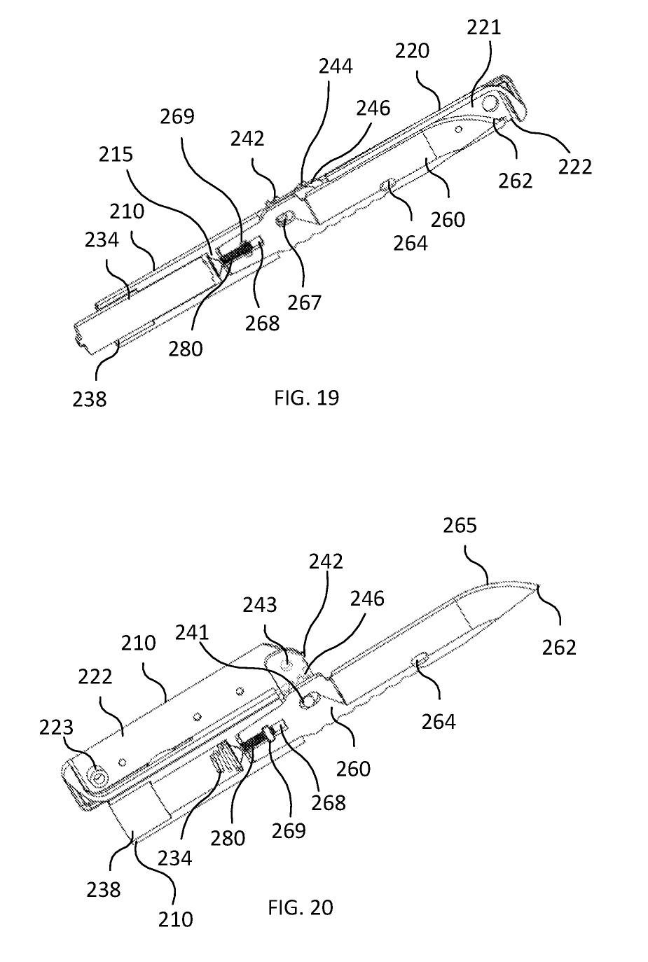

FIG. 19 shows a cross-section perspective view of an example tool arrangement of the multitool 200 in a closed orientation. Handle 220 includes a channel 222 to house knife 260 while the multitool is closed. In this orientation, channel 222 has interior face 221 on handle 220 that is adjacent to the side of blade 260 but has enough clearance for pivot tool 270 between face 221 and blade 260. Blade 260 has a surface defining a slot 267 to receive pivot 241 which in this embodiment couples to both side walls of handle 210 and through slot 267. In this embodiment, pivot 243 has two segments, a first segment connects a first sidewall of handle 220 to link 246, and a second segment connects a second sidewall of handle 220 to link 246. In this arrangement, the two segments of pivot 243 are in axial alignment to allow pivoting around one pivot center. Handle 220 further includes post 223 to receive pivot tool 270.

With reference to FIGS. 19 and 20, blade 260 also has an open channel 268 to receive threaded member 289 and nut 269, such that when blade 260 is placed within handle 210, nut 269 rests in a slot in channel 268 and threaded member 280 extends through a wall 215 with a head of threaded member 280 on one side of wall 215 and the nut 269 within channel 268 on a second side of wall 215. In this way, threaded member 280 can be tightened and secure blade 260 in a fixed arrangement to handle 210. Other embodiments may use alternate connections to fix blade 260 to handle 210 within the principles of this disclosure.

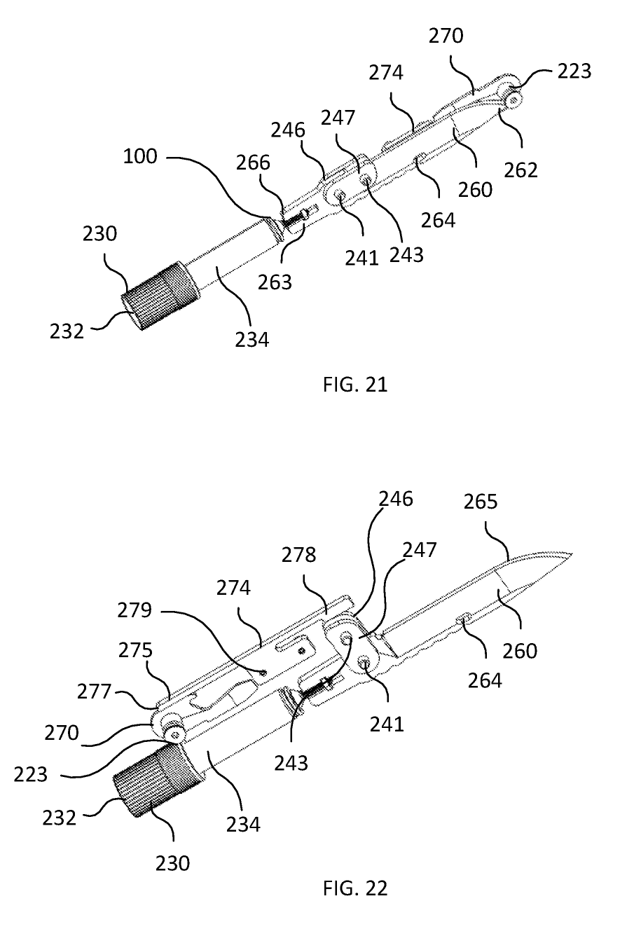

In the open orientation as shown in FIG. 20, handle 220 is rotated adjacent to handle 210 wherein link 246, gears 242 and 244 and pivots 243 and 241 translate handle 220 while it rotates so it can rest in a substantially parallel position to handle 210 while multitool 200 is in an open orientation. Handle 220 includes opening 238 which receives battery 234 into cavity 236, wherein when the battery is inserted into cavity 236 it rests against spring 237 to push the battery against a terminal on light 230 and complete an electrical circuit, as shown in FIG. 21.

FIG. 21 shows a cutaway perspective view of a closed orientation of the internal tool arrangement of the embodiment multitool 200 shown in FIG. 15. With reference to the figure, light 230 is oriented in line with battery 234 which rests against spring 237 in line with threaded member 280 that couples the blade 260 to handle 210 by tightening nut 269 against a channel wall in tang prong 263 and tang prong 266. Blade 260 extends in an axial direction to light 230, battery 234 and threaded member 280 and pivot 241 couples through links 246 and 247 to handle 220 which houses pivot tool 270 which rotates about post 223 and is situated adjacent to blade 260 and face 221 of handle 220. In multitool 220, the internal tools are placed substantially in a line within collinear handles 210 and 220 while the multitool is in a closed orientation, providing a small cross-section relative to a conventional multitool in a closed orientation.

FIG. 22 shows a cutaway perspective view of an open orientation of the internal tool arrangement of the embodiment shown in FIG. 15. FIG. 22 shows the same internal tool components as FIG. 21 but in an open orientation of multitool 200. In this orientation, pivot tool 270 on post 223 is oriented away from blade 260 but within handle 220 which is cutaway in this view to show the internal tool arrangement. Pivot tool 270 in this embodiment is a can opener with a regular screw driver at the distal end of the can opener to post 223.

Pivot tool 270, while closed within handle 220, rests against first cantilevered member 275 on face 277 which operates as a spring tending to resist rotation of pivot tool 270 around post 223 when pivot tool 270 is in a closed position. First cantilevered member 275 is coupled with liner 274 which is connected to handle 220 with fasteners 279. Liner 274 is coupled to second cantilevered member 278 which rests on link 246 when multitool 200 is in an open and a closed orientation. In this arrangement, as pivot tool 270 is opened against first cantilevered member 275, some of the force from cantilevered member 275 is distributed through second cantilevered member 278 to link 246 instead of through handle 220 and pivot 243.

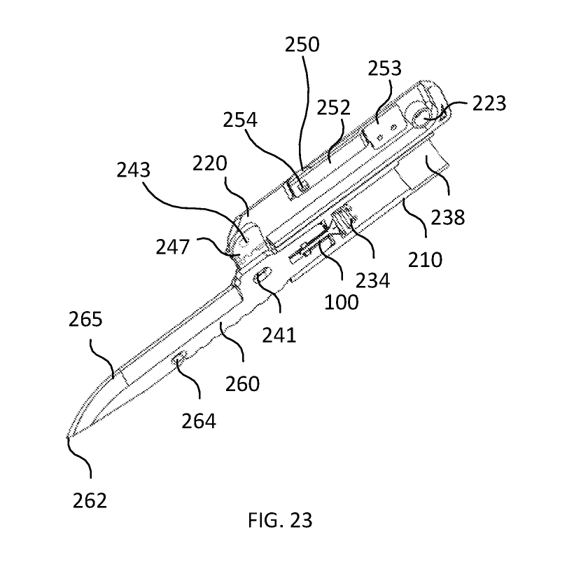

FIG. 23 shows a cutaway perspective view of an open orientation of the internal tool arrangement of the embodiment multitool 200 shown in FIG. 15. In this view, knife 260 is shown fastened to handle 210 with threaded member 280. Pivot 241 is shown extending through blade 260 and coupling link 247 which is coupled to handle 220 by pivot 243. In an open orientation, blade 260 is exposed so knife edge 265 and blade tip 262 are available for use while handle 220 is adjacent to handle 210.

With reference to the figure, handle 220 is fastened to lock 250 at plate 253 which is connected to spring arm 252 to latch 254. In a closed orientation, latch 254 protrudes into notch 264 in blade 260 and locks handle 220 in a collinear arrangement with handle 210 and multitool 200 is in a closed orientation. In this way, a liner lock is used to lock a handle in place, and when the lock is disengaged, the handle rotates to a second position and exposes a fixed blade knife 260 while the multitool 200 is in an open orientation. In the current embodiment, fasteners 279 are used to secure lock 250 to handle 220 and also used to secure clip 204 to handle 220, but other embodiments are not limited to this arrangement.

FIG. 24 shows a top perspective view of a third embodiment multitool 300 having a straight stored orientation. Multitool 300 has a first handle portion 310 that forms a first handle segment with second handle portion 320, and a second handle segment including third handle portion 330 and fourth handle portion 340. In the figure, second handle portion 320 includes angled face 329 which aligns with adjacent face 349 on fourth handle portion 340 when multitool 300 is in a closed orientation. First handle portion 310 and third handle portion 330 have similar angled faces that align when the multitool is in a closed orientation.

Multitool 300 has an opening 318 situated between handle segments near a pivot and housing first plier 360 and second plier 370. In this embodiment, first plier 360 and second plier am 370 have handles that are arranged at an angle to the first and second handle segments as will be described with reference to FIG. 27. When the two handle segments are pulled apart, first plier 360 and second plier 370 slide out and move laterally to the handle segments and in this way, provide clearance for the tool handles to be in a closer arrangement while pliers are open and multitool 300 is in an open orientation. In the present embodiment opening 318 is defined by first handle portion 310 and second handle portion 320, but in other embodiments the opening may be defined by handle portions 330 and 340, or by all handle portions.

As shown in the figure, multitool 300 also has an opening 355 on a first handle segment that is defined by opening 312 on first handle portion 310 and opening 322 on second handle portion 320, which is open to pivot tools 350, 351, 352 and 353 which in turn rotate about pivot 354. In this way, any of pivot tools 350-353 may be opened for use at one end of multitool 300 while the multitool is in a closed with the handle segments in a collinear arrangement. In similar fashion, multitool 300 has an opening 345 on a second handle segment that is defined by opening 332 on third handle portion 330 and opening 342 on fourth handle portion 342, which is open to pivot tools 380-383. In this way, any of pivot tools 380-383 may be opened for use at one end of multitool 300 while the multitool is in a closed with the handle segments in a collinear arrangement.

FIG. 25 shows a cutaway view of the third embodiment multitool 300 shown in FIG. 24. In this cutaway view, first plier 360 includes a first plier arm 362 which extends into the second handle segment comprising third handle portion 330 and fourth handle portion 340. In similar fashion, second plier 370 includes a second plier arm 372 which extends into the first handle segment comprising first handle portion 310 and second handle portion 320.

As shown, pivot tools 350-353 are situated within the first handle segment between first handle portion 310 and second handle portion 320, and adjacent to second plier arm 372 which is also situated primarily within the handle segment. Rocker 390 includes a lock 392 which extends into notches in pivot tools 350-353 in both an open and closed orientation of each of the pivot tools. In this embodiment, pivot tools 380-383 are situated within the second handle segment between the third handle portion 330 and the fourth handle portion 340, and adjacent to first plier arm 362 which is also situated primarily within the handle segment.

As shown, while in a closed orientation, multitool 300 has pivot tools situated on a first side of second plier arm 372 and on the opposing side of first plier arm 362, but other embodiments are not so limited. This arrangement provides a compact closed orientation that can house relatively large plier heads and arms along with multiple pivot tools within handle segments that are substantially collinear while in a closed orientation.

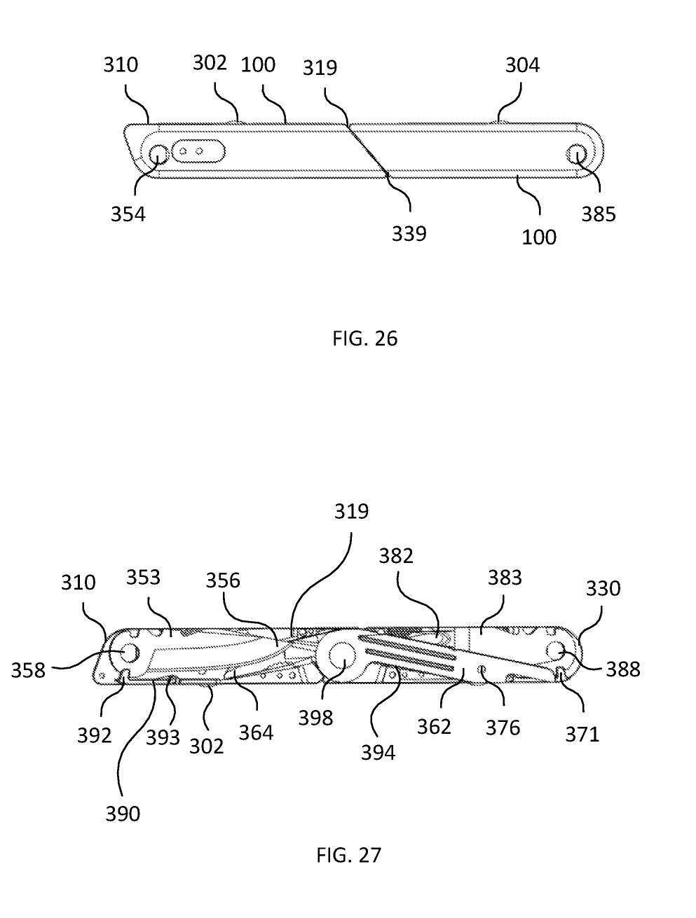

FIG. 26 shows a side view of the third embodiment of a multitool 300 shown in FIG. 24. In this view, first handle portion 310 and third handle portion 330 are shown in a collinear arrangement while the multitool 300 is in a closed orientation. Also shown are angled face 319 and angled face 339 shown adjacent to each other in this closed orientation. Pivot 385 and pivot 354 are shown at the ends of multitool 300 and button 302 which releases the lock 392 on pivot tools 350-353 to allow them to rotate about pivot 354 and button 304 which releases the lock on pivot tools 380-383 to allow them to rotate about pivot 385 are also shown. In the figure, the handle segments are in a relatively compact collinear arrangement and pivot tools 350-353 and 380-383 may be rotated out and utilized in this closed orientation of handle segments.

FIG. 27 shows a cutaway view of the third embodiment multitool 300 also shown in FIG. 24. Handle 330 is shown with pivot tools 382 and 383 having pivot hole 388 which pivot 384 extends through. Lock 371 is shown extending into a notch in pivot tool 383 to lock the pivot tool into a closed position within handle 330. Handle 310 is shown with pivot tool 353 having pivot hole 358 through which pivot 354 extends. Lock 392 is shown within a notch in pivot tool 353 to lock pivot tool 353 in a closed position within handle 310. Rocker 390 pivots about rocker pivot 393, such that when button 302 is pressed, lock 392 disengages from the notch in pivot tool 353 and allows pivot tool 353 to rotate about pivot 354 to an open position.

In this view, the angled orientation of first plier arm 362 in relation to third handle portion 330 can be seen. Second plier arm 372 has a similar angled orientation with respect to first handle portion 310 as can be seen by angled plier channel 311 which houses second plier arm 372. A similar angled plier channel in fourth handle portion 340 coordinates with first plier arm 362. In this view, pivot tools 380-383 are behind first plier arm 362 while pivot tools 350-353 are in front of second plier arm 372. This closed orientation view shows a 180-degree rotated view from that shown in the non-cutaway view shown in FIG. 26.

As the two handle segments are pulled apart in an axial direction 550, the angled relationship between first plier arm 362 and third handle portion 330 and fourth handle portion 340 as well as the angled relationship between second plier arm 372 and first handle portion 310 and second handle portion 320, will move the plier heads and pivot 398 partially outside the collinear arrangement of the handle segments in the closed position. In this way, the handle segments will provide less obstruction to the rotation about pivot 398 and will allow an open orientation with handle segments more closely aligned as they are offset from the plier heads, as can be seen with reference to the fourth embodiment multitool 400 having a similar construction and as shown in FIGS. 29, 31 and 34 and described below.

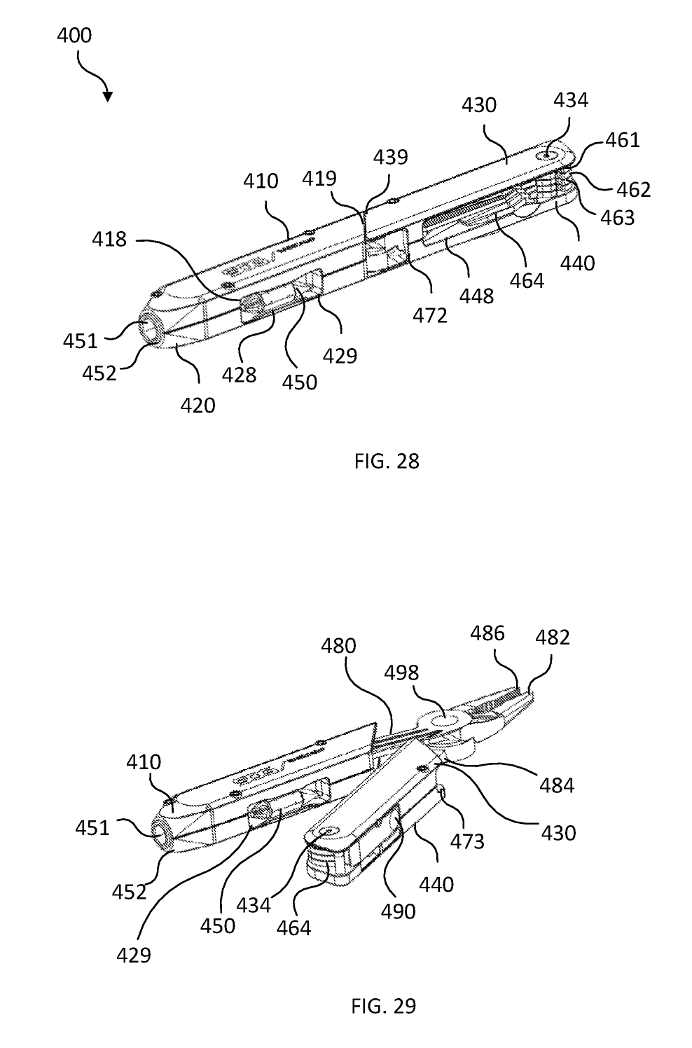

FIG. 28 shows a bottom perspective view of a fourth embodiment multitool 400 having a straight stored orientation. Multitool 400 includes a first handle portion 410 that forms a first handle segment with second handle portion 420, and third handle portion 430 that forms a second handle segment with fourth handle portion 440. In the present embodiment, the first handle segment has a ratchet tool 451 situated at one end, and a cavity 429 defined by opening 418 and opening 428, and that houses a bit 450 that fits within ratchet tool 451. The current embodiment shows ratchet tool 451 and bit 450, but other embodiments are not so limited. As one example, the first handle segment may house a fixed bit receptacle as opposed to a ratcheting tool and the bit 450 can fit within the fixed bit receptacle for use or may be stowed in a cavity 429 as in the current embodiment. On the second handle segment a pivot 434 extends through pivot tool 461, pivot tool 462, pivot tool 463 and pivot tool 464 in similar fashion to the pivot tools in multitool 300 as described above.

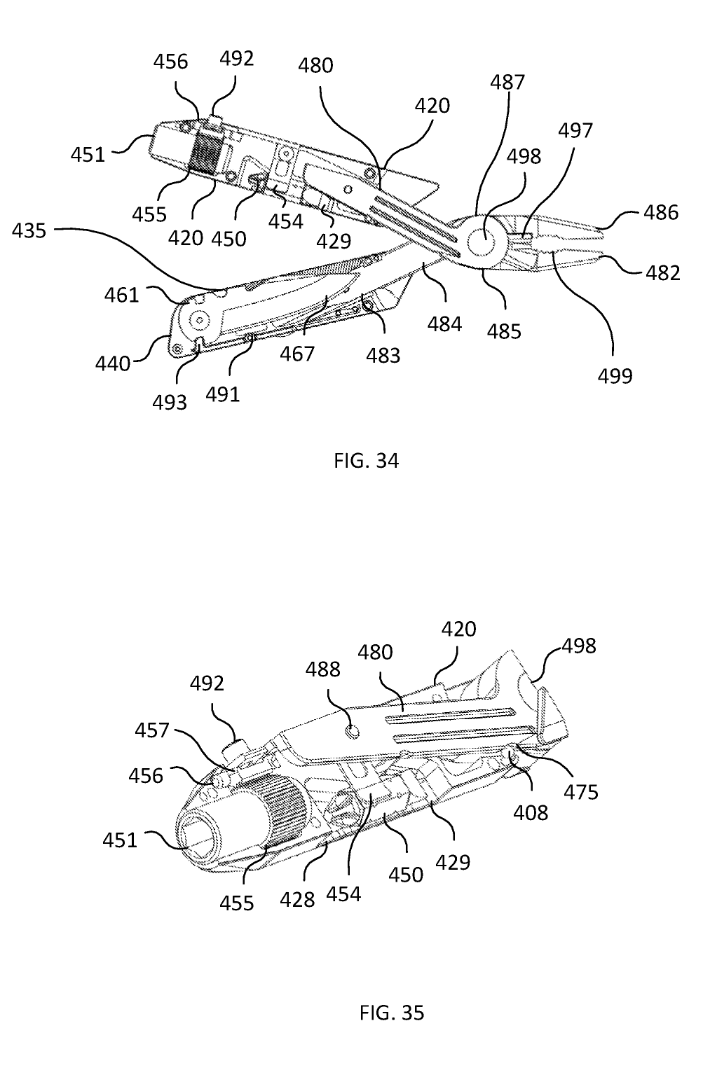

With reference to the figure, third handle portion 430 has an opening 438 that coordinates with opening 448 in handle portion 440 to create a cavity 409 that houses pivot tools 461-464 and allows the pivot tools to rotate about pivot 434 to an open position through opening 448 and opening 438. Third handle portion 430 includes an opening 471 that coordinates with opening 472 in fourth handle portion 440 to allow first plier tool 480 and second plier tool 484 to slide out to a laterally offset position as shown in FIGS. 31 and 34 when the plier is extended and multitool 400 is in an open orientation.

FIG. 29 shows a bottom perspective view of the fourth embodiment multitool 400 in an open orientation. In this open orientation, first plier arm 480 is slidably extended from the first handle segment including first handle portion 410 and second handle portion 420 and second plier arm 484 is slidably extended from the second handle segment including third handle portion 430 and fourth handle portion 440 such that first plier head 482 and second plier head 486 are rotated about pivot 498 into an operational position with plier heads adjacent to each other. As shown, bit 450 is housed within cavity 429 and pivot tools 461-464 are in a closed position about pivot 434 within the second handle segment. In the open orientation, ratchet tool 451 and pivot tools 461-464 may still be utilized. In the current embodiment, bit 450 and cavity 429 and facing the inside of the handle with respect to the pliers being in an open position, but other embodiments are not limited to this construction.

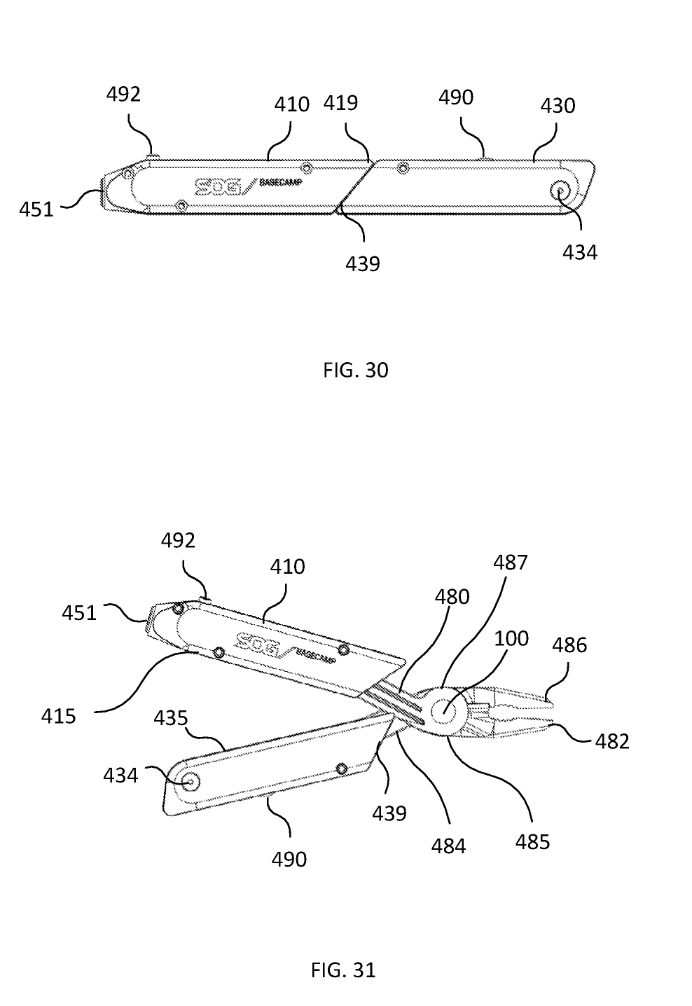

FIG. 30 shows a side view of the fourth embodiment multitool 400 shown in FIG. 28. As shown, first handle portion 410 is part of a first handle segment and third handle portion 430 is part of a second handle segment wherein the handle segments are in a collinear arrangement while the tool is in a closed orientation. In this orientation, the handle segments encapsulate two plier arms rotated anti-parallel to each other, a ratchet tool 451 and a bit 450, and pivot tools 461-464. Button 492 switches which direction ratchet tool 451 will ratchet bit 450. Button 490 operates a rocker arm that locks and unlocks pivot tools 461-464 as they rotate about pivot 434. Angled face 419 is adjacent to angled face 439 while multitool 400 is in a closed orientation.

FIG. 31 shows a side view of an open orientation of the fourth embodiment multitool 400 shown in FIG. 28. In this view, first plier arm 480 is extended from the handle segment having first handle portion 410 and second plier arm 484 is extended from the second handle segment having third handle portion 430. In this open orientation of multitool 400, button 492 is operational on the outside of first handle portion 410 and button 490 is operational on the outside of third handle portion 430.

With reference to FIG. 31, first plier head 482 and second plier head 486 are extended from the handle segments and first plier arm 480 and second plier arm 484 are rotated about pivot 498 to an open orientation of multitool 400. As can be seen in the figure, plier side 487 extends in a lateral direction with respect to handle side 435 on the second handle segment and plier side 485 extends in a lateral direction with respect to handle side 415. This creates a lateral offset of the plier head in relation to the handle segments that allows the handle segments to rotate around to a close arrangement when the plier is in an open orientation.

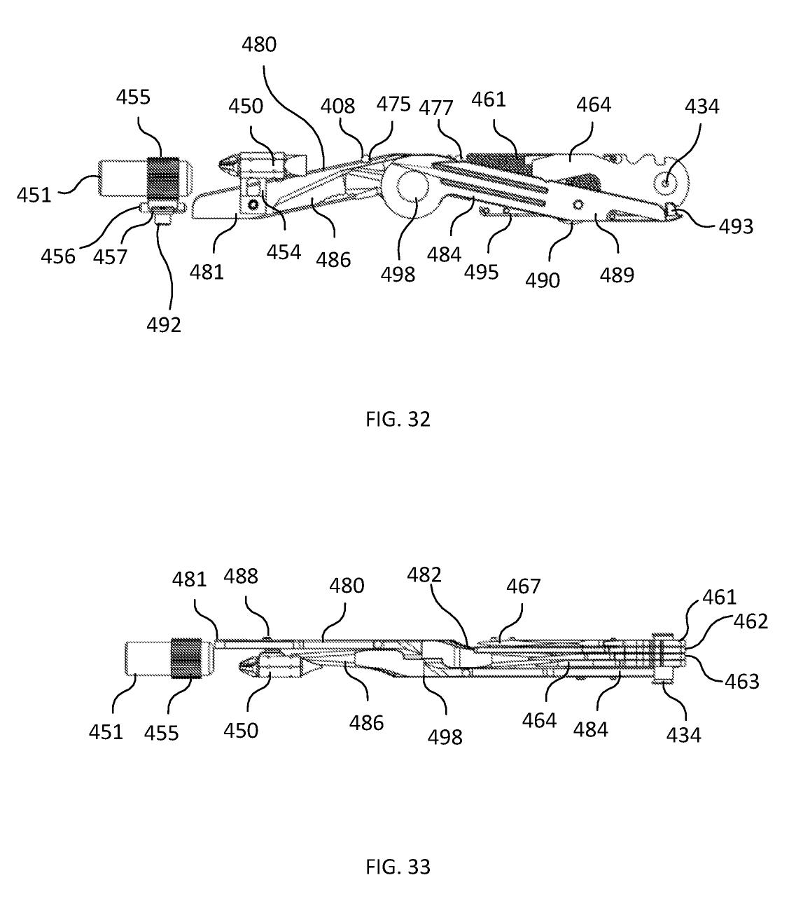

FIG. 32 shows a side cutaway view of the internal tool arrangement of the fourth embodiment multitool 400 shown in FIG. 28. In this view, the substantially linear arrangement of the component tools can be seen while the multitool 400 is in a closed orientation. Ratchet tool 451 includes ratchet teeth 455, ratchet latch 457 in communication with ratchet teeth 455 and pivot 456, and ratchet switch 492 to adjust ratchet latch 457 about pivot 456 to configure ratchet tool 451 in a clockwise or counterclockwise ratchet configuration.

Bit 450 is secured by bit retention spring 454 which holds bit 450 against the wall of cavity 429 in a releasable manner. First plier arm 480 includes first plier arm end 481 adjacent to bit 450 and bit retention spring 454 and alongside second plier head 486 while the plier is in a closed orientation and the handle segments are in a collinear arrangement. Plier arm 480 includes a notch 475 to receive ball bearing 408 in similar fashion to the embodiment described with reference to FIGS. 9-10 above.

Second plier arm 484 is coupled with first plier arm 480 by pivot 498. With reference to the figure, while the internal tool arrangement is substantially linear, the angled plier arms 480 and 484 can be seen wherein the plier arms are angled with relation to the handle portions but still within the handle segments such that the first and second handle segments maintain a collinear arrangement while multitool 400 is in a closed orientation. Second plier arm 484 is also adjacent to pivot 434 and pivot tools 461-464 which rotate about pivot 434 and are locked by lock 493, as described above with reference to other embodiments. As shown, ratchet tool 451 is substantially in line with the first plier arm 480 and second plier arm 484, while bit 450 is stored adjacent to first plier arm 480 and pivot tools 461-464 are adjacent to second plier arm 484 and second plier arm end 489. In this arrangement, as plier arms are arranged adjacent and not fully collinear to each other, there are alternate open spaces to place tools and components in close adjacency to the plier tool arms and in turn to have a more compact handle cross-section in a multitool with a linear arrangement, as can be seen in FIG. 33 as described below.

FIG. 33 shows a bottom cutaway view of the internal tool arrangement of the fourth embodiment multitool 400 shown in FIG. 28. In this top view of the multitool 400 in a closed orientation, the ratchet tool 451 can be seen substantially in line with the first plier arm 480 and second plier arm 484, and bit 451 is adjacent to first plier arm 480. Pivot 434 retains pivot tools 461-464 which in a closed position are adjacent to second plier arm 484. As shown in this view, pivot tool 464 and pivot tool 463 are shorter than pivot tools 462 and 461 comprising a file and knife 467, and thus can fit adjacent to second pivot tool arm 484 but around first plier head 482. Longer pivot tools 462 and 461 extend adjacent to first plier head 482 and are adjacent to pivot tools 463 and 464. In this way, a more compact arrangement within handle segments can be achieved and still maintain a collinear arrangement of handle segments in a closed orientation.

FIG. 34 shows a side cutaway view of the internal tool arrangement of the fourth embodiment multitool in an open orientation. As shown in the figure, first plier head 482 and second plier head 486 are extended from the handle segments and first plier arm 480 and second plier arm 484 are rotated about pivot 498 to an open orientation of multitool 400. First plier head 482 and second plier head 486 include open gripping portion 499 and wire cutter 497, but other embodiments are not so limited. As can be seen in the figure, plier side 487 extends in a lateral direction with respect to handle side 435 on the second handle segment and plier side 485 extends in a lateral direction with respect to handle side 415. This creates a lateral offset of the plier head in relation to the handle segments that allows the handle segments to rotate around to a close arrangement when the plier is in an open orientation.

With reference to FIG. 34, first plier arm 480 and second plier arm 484 are slidably extended to an open orientation. In this cutaway view, the ratchet tool assembly, bit 450 and pivot tools 461-464 are shown within the first and second handle segments. Fourth handle portion 440 includes angled walls 483 to retain angled sidewalls on second plier arm 484 with similar structure to angled wall 173 and ramped sidewalls 179 as shown and described with reference to first embodiment multitool 100 above.

FIG. 35 shows an end perspective cutaway view of the fourth embodiment multitool 400 shown in FIG. 28. In this cutaway view, first plier arm 480 is angled into the first handle segment comprising second handle portion 420, and pivot 498 and plier heads are arranged within the handle segments which are in collinear arrangement in a closed orientation. In the figure, ball bearing 408 is shown within notch 475 in first plier arm 480, thus securing first plier arm 480 in a closed orientation within the handle segment. Cavity 429 is shown adjacent to first plier arm 480 and bit retention spring 454 holds bit 450 against second handle portion 420 while being accessible through opening 428. Ratchet tool 451 includes ratchet teeth 455, ratchet latch 457 in communication with ratchet teeth 455 and pivot 456, and ratchet switch 492 to adjust ratchet latch 457 about pivot 456 to configure ratchet tool 451 in a clockwise or counterclockwise ratchet configuration.

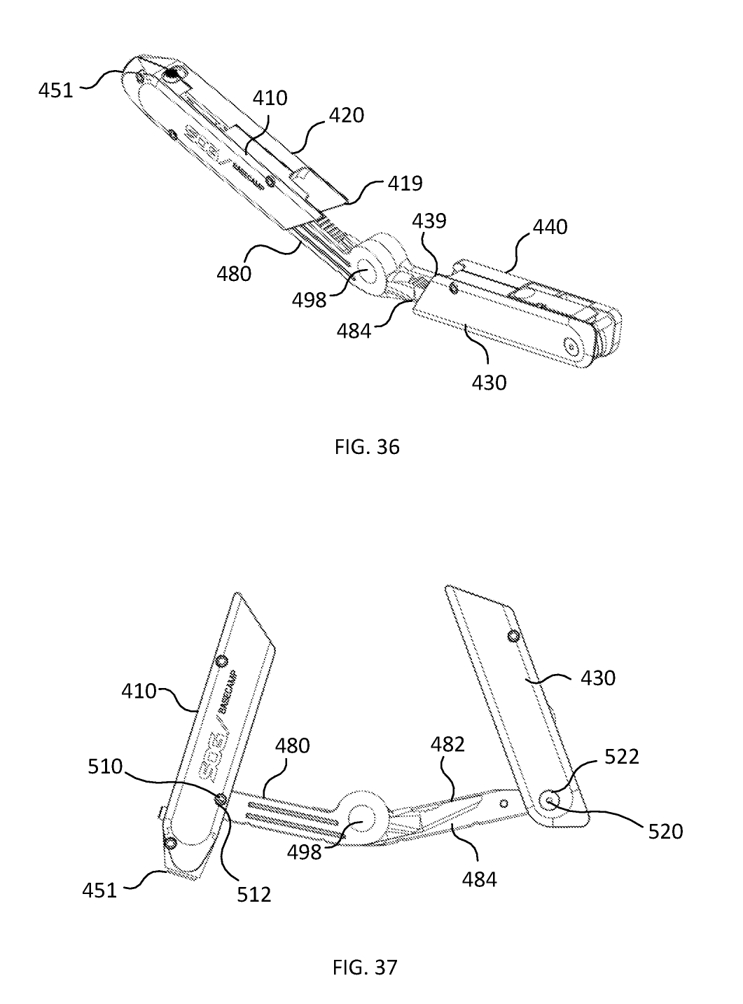

FIG. 36 shows a side perspective view of a fifth embodiment multitool 500 as disclosed herein. The multitool shown in FIG. 36 may have a similar closed orientation to fourth embodiment multitool 400 as illustrated in FIG. 30 and described above. Fifth embodiment multitool 500 may open to a non-collinear handle orientation when the first handle segment including handle portions 410 and 420 are slidably extended away from the pivot of the pivot tool. For example, angle face 419 which is adjacent angled face 439 in a closed position, may rotate such that the faces are no longer in a substantially parallel arrangement when the handle segments are slidably extended away from the pivot along pivot tool arm 480 and pivot tool arm 484. Therefore, in embodiments similar to illustrated fifth embodiment 500, the handle segments are collinear in a closed orientation and then once the handles are extended the handle segments form a non-180-degree angle about pivot 498. In other embodiments, the collinear arrangement of the handle segments may be maintained as the handle segments are extended along pivot tool arms.

FIG. 37 shows a side view of a sixth embodiment multitool 600 as disclosed herein. In this embodiment, in a closed orientation the handle tool segments may be substantially in a substantially collinear arrangement such as is depicted in the fourth embodiment multitool 400 in FIG. 30. In other embodiments, the handle tool segments may be at a non-collinear arrangement in the closed position. For the sixth embodiment 600, the handles are in a substantially collinear arrangement in a closed position, but then instead of being slidably connected to pivot tool arms, the handle segments are pivotably attached near the end of the pivot tool arms by pivots 510 and 520 which extend through pivot holes 512 and 522. FIG. 37 depicts the handle segments in a half-open position. As the handle segments rotate to an open position, they may either line up with the pivot tool arms or be at a slightly non-collinear arrangement to the pivot tool arms 480 and 484. In this way, a substantially collinear multitool in a closed position can rotate to an open position and be used as pliers or other pivot tools.

It will further be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of any of the above-described processes is not necessarily required to achieve the features and/or results of the embodiments described herein, but is provided for ease of illustration and description.

The subject matter of the present disclosure includes all novel and nonobvious combinations and subcombinations of the various processes, systems and configurations, and other features, functions, acts, and/or properties disclosed herein, as well as any and all equivalents thereof.

1. A multitool, comprising:
a first handle segment having a first handle portion and a second handle portion, the first handle segment having an internal channel housing a first pivot tool arm;
a second handle segment having a third handle portion and a fourth handle portion, the second handle segment having an internal channel housing a second pivot tool arm; and
a pivot to rotatably couple the first pivot tool arm to the second pivot tool arm to create a pivot tool, wherein the pivot can rotate the first pivot tool arm and second pivot tool arm into a substantially straight arrangement allowing the first handle segment to be substantially collinear with the second handle segment when the multitool is in a closed orientation.

2. The multitool of claim 1, wherein the first pivot tool is scissors.

3. The multitool of claim 1, wherein the first handle segment includes a telescoping tool that is stored within the first handle segment in a closed position and extends from the first handle segment in an open position.

4. The multitool of claim 3, wherein the telescoping tool is a pen.

5. The multitool of claim 1, wherein the second handle segment includes a sliding tool that is stored within the second handle segment in a closed position and extends from the second handle segment in an open position.

6. The multitool of claim 5, wherein the sliding tool is a blade.

7. The multitool of claim 1, further comprising at least one of a spring or a stop to maintain the first handle segment and the second handle segment in a collinear arrangement in a closed orientation.

8. The multitool of claim 7, further comprising at least one of a spring or a stop to maintain the first handle segment and the second handle segment in a fixed open position.

9. The multitool of claim 1, wherein the first pivot tool arm is slidably connected to the first handle segment, and the second pivot tool arm is slidably connected to the second handle segment.

10. A multitool, comprising:
a first handle having a first angled inner channel to receive a first pivot tool arm;
a second handle having a second angled inner channel to receive a second pivot tool arm; and
a pivot to rotatably couple the first pivot tool arm and second pivot tool arm to create a pivot tool, wherein the pivot can rotate the first pivot tool arm and second pivot tool arm such that the first handle and second handle are in a collinear arrangement with the multitool in a closed orientation.

11. The multitool of claim 10, wherein when the first pivot tool arm is slidably extended through the first angled inner channel in the first handle.

12. The multitool of claim 11, wherein the second pivot tool arm is slidably extended through the second angled inner channel in the second handle.

13. The multitool of claim 12, wherein the pivot tool is partially offset from the first handle and second handle.

14. The multitool of claim 12, wherein when the pivot tool is rotated to a closed position and the first handle and second handle are extended, the first angled inner channel and the second angled inner channel place the first handle in a closer position to the second handle than if the first and second angled inner channels were collinear with the pivot tool arms.

15. The multitool of claim 12, wherein when the first pivot tool arm is slidably extended and the second pivot tool arm is slidably extended, the first handle and second handle are at a smaller than 180-degree angle with respect to each other, wherein when in the closed position the first handle and second handle are substantially collinear with each other.

16. The multitool of claim 12, wherein when the first pivot tool arm and second pivot tool arm are in a nonextended position, the pivot tool can rotate further open until the first handle is substantially collinear with the second handle.

17. The multitool of claim 16, wherein a side portion of the pivot tool protrudes from at least one of the first handle and the second handle when the first handle is substantially collinear with the second handle.

18. The multitool of claim 10, wherein first angled inner channel receives the first pivot tool arm, wherein the handle has a cavity adjacent to the first angled inner channel and defined by interior walls and an opening in the handle, wherein the cavity can store a tool.

19. The multitool of claim 18, wherein the tool is a bit.

20. (canceled)

21. A multitool, comprising:
a first handle having a first interior channel and a first arm of a pivot tool, the first arm of the pivot tool having a first tang and a first working head;
a second handle having a second interior channel and a second arm of a pivot tool, the second arm of the pivot tool having a second tang and a second working head; and
wherein in a closed position, the pivot is rotated substantially open such that the first tang of the pivot tool and the second working head of the pivot tool reside substantially within the first handle and the second tang of the pivot tool and the first working head of the pivot tool reside substantially within the second handle.

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)
